(19) United States
(12) Patent Application Publication
(10) Pub. No.: US 2025/0354360 A1
(43) Pub. Date: Nov. 20, 2025

(54) SYSTEM AND METHOD FOR A SANITARY UNIT AND CONTROLLING A SANITARY UNIT

(71) Applicant: BLANCO GMBH + CO KG, Oberderdingen (DE)

(72) Inventor: Steven SCHUSS, Pfinztal (DE)

(73) Assignee: BLANCO GMBH + CO KG, Oberderdingen (DE)

(21) Appl. No.: 19/207,821

(22) Filed: May 14, 2025

(30) Foreign Application Priority Data
May 16, 2024 (DE) 10 2024 204 532.2

(51) Int. Cl. E03C 1/05; E03C 1/126; E03C 1/266

(52) U.S. Cl. CPC E03C 1/055; E03C 1/126; E03C 1/2665

(57) ABSTRACT

A system for controlling a sanitary unit, preferably a sanitary unit arranged at least partially in a kitchen base unit, is provided comprising a control device which can be arranged on a sanitary unit and at least one, preferably mobile, user operating device, wherein the control device and the operating device(s) are designed to communicate with one another via a continuously maintained wireless connection, wherein the user's operating command(s) can be transmitted to the control device by the operating device(s), with at least one function of the sanitary unit controlled by the control device based on the received operating command(s), with the function(s) controlled depending on the wireless connection's signal strength, with the control device designed to notify the user of the sanitary unit's status after a predeterminable signal strength threshold has been exceeded and/or fallen below and to provide controllability of the function(s) after a predeterminable time period has elapsed and/or after the user confirms the status.

The invention relates to a system for controlling a sanitary unit, preferably a sanitary unit arranged at least partially in a kitchen base unit.

The invention also relates to a sanitary unit with a control system.

The invention also relates to a method for controlling a sanitary unit.

EP 3 236 709 B1 describes a cooking appliance that can be controlled via a Bluetooth connection with a smartphone. The cooking appliance connects to the smartphone as soon as a certain signal strength threshold is exceeded. If there is a connection, the appliance can be fully controlled. If the signal strength falls below a presettable minimum value, operating commands for appliance control are blocked.

The appliance can also be controlled out of sight of the cooking appliance despite sufficient signal strength. This can lead to insufficient monitoring of the cooking appliance.

It is therefore a goal of this invention to provide a system, a sanitary unit and a method for controlling a sanitary unit which enable safe and convenient control of the sanitary unit by means of a simple design.

A further goal of this invention is to provide an alternative system, an alternative sanitary unit and an alternative method for controlling a sanitary unit.

In one embodiment, this invention achieves the above-mentioned goals with a system for controlling a sanitary unit, preferably a sanitary unit arranged at least partially in a kitchen base unit, comprising a control device which can be arranged on a sanitary unit and at least one, preferably mobile, user operating device, the control device and the operating device(s) being designed to communicate with one another via a continuously maintained wireless connection, with the user's operating command(s) transmitted to the control device by the operating device(s), wherein the function(s) of the sanitary unit can be controlled by the control device based on the received operating command(s), whereby the function(s) can be controlled under a signal strength of the wireless connection, wherein the control device is designed to notify the user of the sanitary unit's status after the signal strength exceeds and/or falls below a predeterminable threshold and to provide controllability of the function(s) after a predeterminable time period has elapsed and/or after the user confirms the status notification.

In one embodiment, this invention solves the aforementioned problems with a sanitary unit, preferably a sanitary unit arranged at least partially in a kitchen base unit, with a system according to one of Claims 1 to 14.

In one embodiment, this invention solves the aforementioned goals with a method for controlling a sanitary unit, preferably a sanitary unit arranged at least partially in a kitchen base unit, with a system according to one of Claims 1 to 14. The procedure comprises the following steps:
establishing the wireless connection between the control device and the operating device(s),
determining the signal strength of the wireless connection by the control device and/or the operating device(s), and
notifying the user of the sanitary unit's status after the signal strength exceeds and/or falls below a predeterminable threshold, and
providing controllability of the function(s) after a predeterminable period of time has elapsed and/or after the user confirms the status notification.

One of the advantages of this is that the control of sanitary unit functions, such as the dispensing of hot water, can only be carried out at certain signal strengths. In other words, this can mean that the controllability of the function(s) is activated and/or deactivated at certain signal strengths. The signal strength correlates preferably with the distance between the operating device and the control unit. This ensures, for example, that hot water is only dispensed when the user is in the immediate vicinity with a line of sight to the sanitary unit. This reduces the likelihood of other people, especially children, being directly affected by the dispensing of hot water.

A continuously maintained wireless connection is advantageous in that the signal strength can be continuously determined. This prevents anyone with an operating device approaching the sanitary unit from not being detected or not being detected in time. This increases the safety of the system.

The term “signal strength” is to be understood in the broadest sense and refers, preferably in the Claims and preferably in the description, to the intensity, strength or amplitude of a signal transmitted between the control device and the operating device(s). A higher signal strength can mean that the control device and the operating device(s) are at a smaller distance from each other and/or that the signal is less affected by obstacles between the control device and the operating device(s).

Further features, advantages and further embodiments of the invention are described or disclosed below.

According to a preferred embodiment of the invention, at least two functions can be provided, wherein at least one defined signal strength threshold value is assigned to at least some of the functions and/or at least one function category with one or more functions, wherein the functions can be controlled above and/or below the threshold(s). This makes it particularly easy to ensure that the user is in the immediate vicinity of the sanitary unit when controlling safety-critical functions. The threshold value can be defined in such a way that the user is at a short distance, for example maximum 1 m, from the sanitary unit and that there are no obstacles between the user and the sanitary unit that could impair the wireless signal. It is conceivable, for example, that the control of safety-critical functions, such as the dispensing of hot water, is activated above a threshold value assigned to this function and deactivated below this threshold value. Functions, such as the dispensing of hot water, can be controlled above a threshold value of 60%, preferably 80%, most preferably 90%, of maximum signal strength. Functions that are less or not safety-critical can be controlled above a lower threshold value. By assigning several functions to a function category, the implementation effort in relation to the control software can be reduced.

According to another preferred embodiment of the invention, the control device has at least one, preferably visual, signaling device, wherein the signaling device(s) are designed to notify the user of the sanitary unit's status. One of the advantages of this is that the user can easily recognize the status of the sanitary equipment, thus increasing safety when controlling the system. It is conceivable that the signaling device(s) comprise an LED device. For example, the LED device can be designed to light up red if a set water temperature is above a certain value.

According to another preferred embodiment of the invention, the function(s) can be controlled by the user confirming the status on the operating device. The option of additionally confirming the signaled status via the control unit further increases safety when controlling the system.

According to another preferred embodiment of the invention, the status can be signaled over a defined period of time, preferably at least 0.5 s and a maximum of 5 s, preferably 2 s. The advantage of this is that the user has sufficient time to detect and recognize the signaled status and at the same time the user experience is not impaired by the status being signaled for too long.

According to another preferred embodiment of the invention, the status can be transmitted to the operating device(s) by the control device after the threshold(s) have been exceeded and/or not reached. One of the advantages of this is that the user can detect and recognize the status particularly easily and quickly.

According to another preferred embodiment of the invention, the status relates to a current setting, for example a set fluid characteristic of a fluid to be dispensed by a fluid dispensing device and/or a current position of a fluid outlet, and/or a current status, for example a current filling level of a waste container and/or a current condition of a water filter. By signaling a current setting, the user does not have to re-enter the setting, which improves the user experience. Notifying the user of a current status can also improve the user experience, as the current status is displayed to the user without them having to determine it themselves. The current status helps the user decide what to do next. For example, the current status of a waste bin can be notified by showing the maximum fill level. The user can therefore decide to empty the waste can on the basis of this information.

According to another preferred embodiment of the invention, the operating device(s) can be identified by the control device, whereby the function(s) can be controlled depending on the detection result. This can permanently prevent the control of functions for certain persons or groups of persons who are assigned to an identified operating device. Such persons or groups of persons may include children. This can increase supervision in controlling the system. In principle, country-specific standards relating to data protection regulations can be observed.

According to another preferred embodiment of the invention, a defined user preference can be set by the control device after exceeding and/or falling below the threshold(s), preferably wherein at least two functions can be provided, with the user preference assigned to the detection result and at least some of the functions and/or at least one function category with one or more functions. The advantage of this is that it enables at least partially automated control of the sanitary unit and thus increases user-friendliness.

According to another preferred embodiment of the invention, at least two operating devices are provided for the sanitary unit, wherein a proximity notification can be transmitted to another of the operating devices by the control device after a signal strength threshold assigned to one of the operating devices has been exceeded. One of the advantages of this is that another person is notified when certain people or groups of people, such as children, approach the sanitary unit. This increases the safety of the system.

According to another preferred embodiment of the invention, the operating device(s) have a display device for indicating activation and/or deactivation of the control. This means that the user can immediately see whether they are already close enough to the sanitary unit and it makes the system more user-friendly.

According to another preferred embodiment of the invention, the sanitary unit comprises at least one of the following: water fittings, a sink, a waste system, a waste disposal unit, a water treatment unit, a dehumidifier. These units are particularly suitable for implementing the system, as they include functions such as the dispensing of hot water or the use of a food waste disposal masher. In addition, the user has a high degree of flexibility in selecting units that can be controlled by means of an operating device.

According to another preferred embodiment of the invention, the wireless connection is based on the data transmission standard Bluetooth, Bluetooth Low Energy, WLAN, WiFi, Zigbee, NFC, Sigfox, Li-Fi or Mioty. Depending on requirements and boundary conditions, these can be used if low power consumption, high availability, a high data rate, a long range and the like are required.

According to another preferred embodiment of the invention, the operating device(s) include a cell phone and/or a smartwatch. Such mobile operating devices are usually worn directly on the body by the user or other persons, so that the distance between the operating device and the sanitary unit corresponds to the distance between the user or other persons and the sanitary unit. It is conceivable that the sanitary equipment can be controlled via an app installed on the cell phone and/or smartwatch.

Further important features and advantages of the invention are apparent from the sub-claims, from the drawings and from the associated description of the illustrations with reference to the drawings.

It is understood that the features mentioned above and those to be explained below can be used not only in the combination indicated in each case, but also in other combinations or on their own, without departing from the scope of this invention.

Preferred designs and embodiments of this invention are shown in the drawings and are explained in more detail in the following, with identical references referring to identical or similar or functionally identical components or elements.

The illustrations are as follows.

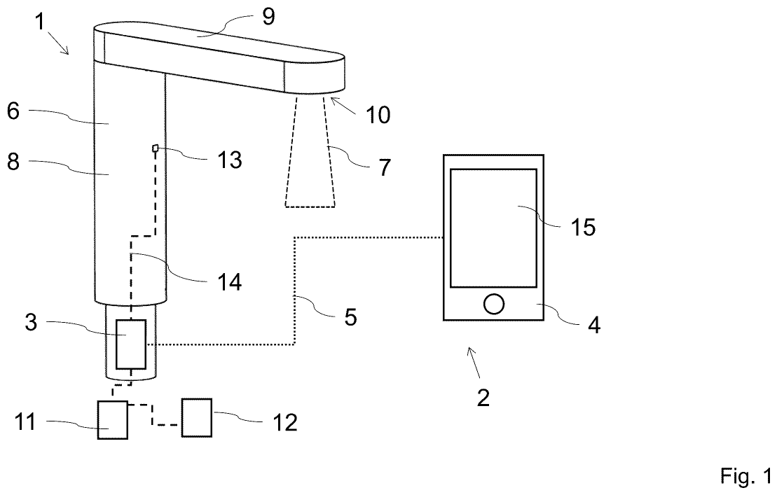

FIG. 1 shows a diagram of one of the invention's sanitary unit embodiments in situ, and

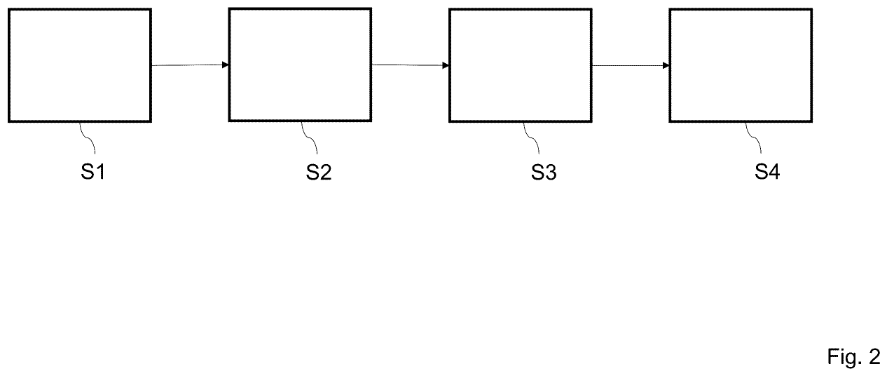

FIG. 2 shows the steps of one process according to one embodiment of this invention.

FIG. 1 shows a schematic view of a sanitary unit according to one embodiment of this invention.

FIG. 1 shows a sanitary unit 1 with a system 2 for controlling the sanitary unit 1, comprising a control device 3 arranged on the sanitary unit 1 and a mobile operating device 4 in the form of a user's cell phone. The control device 3 and the cell phone 4 are designed to communicate with each other via a continuously maintained wireless connection 5. The wireless connection 5 is based on the Bluetooth data transmission standard. The sanitary unit 1 here comprises a water fitting 6 for dispensing water.

At least one user operating command can be transmitted to the control device 3 via the cell phone 4, whereby several functions 7 of the sanitary unit 1 can be controlled by the control device 3 based on the operating command(s) received. The functions 7 can be controlled depending on the signal strength of the wireless connection 5.

The water fitting 6 has a base body 8 extending in a vertical direction and an outlet body 9 extending in a horizontal direction. The outlet body 9 comprises a water outlet opening 10. The water fitting 6 also has an electronic cartridge 11 and a water treatment unit 12 and is designed to dispense tap water, filtered water, carbonated water and hot water.

The water fitting 6 also comprises a signaling device 13 in the form of an LED device, which is arranged in the base body 8. The LED device 13 can be designed to light up red if a set water temperature is above a certain value.

The control device 3 is shown as a diagram in FIG. 1 and is connected to the electronic cartridge 11, the water treatment unit 12 and the LED device 13 via electrical lines 14 for communication. The control device 3 can be arranged in and/or on the water fitting 6 or provided as a separate component.

The controllable functions 7 of the water tap 6 include the dispensing of tap water, filtered water and carbonated water or hot water. A defined signal strength threshold value is assigned to at least some of the functions 7, whereby the functions 7 can be controlled above that threshold. This can mean that the controllability of these functions 7 is activated above the threshold value and deactivated below the threshold value.

For example, the dispensing of hot water is assigned a particularly high threshold value, preferably 90% of a maximum signal strength, in order to ensure that the user is in the immediate vicinity of the water fitting 6 when the water is dispensed. Below this threshold, the output of hot water by the control unit 3 is deactivated, but the other functions can still be controlled depending on the signal strength.

The cell phone 4 has a display device 15 in the form of a screen for displaying activation and/or deactivation of the controls.

In addition, a time period can also be specified during which the signal strength falls below the threshold value without loss of controllability. This takes account of the fact that a user is only away from the sanitary unit 1 for a short time.

It is also conceivable that settings or operating commands made directly on the sanitary unit 1 override or disable commands via the wireless connection 5.

Furthermore, it is conceivable that when the user's cell phone 4 or a smartwatch approaches the sanitary unit 1, user-defined settings for the sanitary unit are made according to a stored user profile.

FIG. 2 shows steps of a method according to one embodiment of this invention.

The method for controlling a sanitary unit 1 can be carried out preferably using a system 2 as shown in FIG. 1.

In a first step S1, the wireless connection 5 is established between the control device 3 and a mobile operating device 4 in the form of a cell phone. This can be fully automated or assisted by the user of the cell phone 4, whereby the user sets up the wireless connection 5 via an app installed on the cell phone 4.

As soon as the wireless connection 5 is established, the signal strength of the wireless connection 5 is determined in a second step S2. This can be done by the control device 3 and/or by the cell phone 4.

Subsequently, in a third step S3, the user is notified of a status of the sanitary unit 1 after the signal strength exceeds and/or falls below a predeterminable threshold. Depending on the increasing or decreasing signal strength of the wireless connection 5, the status of the sanitary unit 1 is displayed to the user.

In a fourth step S4, controllability of the function(s) 7 is then provided after a predeterminable period of time has elapsed and/or after the user confirms the status notification. In other words, the user should first take note of the current status of the sanitary unit 1 before it can be controlled by the user.

Depending on the signal strength of the wireless connection 5, preferably above a defined wireless connection 5 signal strength threshold, the function(s) 7 of the sanitary unit 1 can then be controlled.

In summary, at least one embodiment of this invention may have at least one of the following features and/or may provide at least one of the following advantages:
Increased safety.
Increased user-friendliness.
Reduced implementation effort.
Improved user experience.
Automated control.
Low power consumption.

Although this invention has been described with reference to preferred designs, it is not limited thereto, but can be modified in a variety of ways.

### LIST OF REFERENCE SYMBOLS

1 Sanitary unit
2 System
3 Control unit
4 Control unit, cell phone
5 Wireless connection
6 Water fitting
7 Function
8 Base body
9 Outlet body
10 Water plughole
11 Electronic cartridge
12 Water treatment unit
13 Signaling device, LED device
14 Electrical cable
15 Display device
S1-S4 Steps of the procedure

1. A system for controlling a sanitary unit, preferably a sanitary unit arranged at least partially in a kitchen base unit, comprising a control device which can be arranged on a sanitary unit and at least one, preferably mobile, user operating device,
wherein the control device and the operating device(s) are designed to communicate with one another via a wireless connection, preferably one that is maintained continuously,
wherein at least one operating command of the user can be transmitted to the control device by the operating device(s),
wherein at least one function of the sanitary unit can be controlled by the control device based on the received operating command(s),
wherein the function(s) can be controlled depending on the signal strength of the wireless connection,
wherein the control device is designed to signal the sanitary unit status to a user after exceeding and/or falling below a predeterminable signal strength threshold and to provide controllability of the function(s) after a predeterminable period of time has elapsed and/or after the user confirms the status.

2. The system according to claim 1, characterized in that at least two functions can be provided, wherein at least one defined signal strength threshold is assigned to at least some of the functions and/or at least one function category with one or more functions, wherein the functions can be controlled above and/or below the threshold(s).

3. The system according to claim 2, characterized in that the control device has at least one, preferably optical, signaling device, the signaling device(s) being designed to notify the user of a sanitary unit status.

4. The system according to claim 1, characterized in that the function(s) can be controlled by the user confirming the status on the operating device.

5. The system according to claim 1, characterized in that the status can be signaled over a defined period of time, preferably at least 0.5 s and a maximum of 5 s, preferably 2 s.

6. The system according to claim 1, characterized in that the status can be transmitted by the control device to the operating device(s) after the exceeding or falling below the threshold.

7. The system according to claim 1, characterized in that the status relates to a current setting, for example a currently set fluid characteristic of a fluid to be dispensed by a fluid dispenser and/or a current position of a fluid outlet, and/or a current status, for example a current filling level of a waste container and/or a current condition of a water filter.

8. The system according to claim 1, characterized in that the operating device(s) can be detected by the control device, the function(s) being controllable depending on the detection result.

9. The system according to claim 1, characterized in that after exceeding and/or falling below the threshold(s), a defined user preference can be set by the control device, preferably wherein at least two functions can be provided, with the user preference assigned to the detection hit and at least some of the functions and/or at least one function category with one or more functions.

10. The system according to claim 1, characterized in that at least two operating devices are provided for the sanitary unit, wherein a proximity notification can be transmitted to another of the operating devices by the control device after a signal strength threshold assigned to one of the operating devices has been exceeded.

11. The system according to claim 1, characterized in that the operating device(s) have a display for indicating activation and/or deactivation of the control.

12. The system according to claim 1, characterized in that the sanitary unit comprises at least one of the following: water fittings, a sink, a waste system, a waste disposal unit, a water treatment unit, a dehumidifier.

13. The system according to claim 1, characterized in that the wireless connection is based on the Bluetooth data transmission standard, Bluetooth Low Energy, WLAN, WiFi, Zigbee, NFC, Sigfox, Li-Fi or Mioty.

14. The system according to claim 1, characterized in that the operating device(s) include a cell phone and/or a smartwatch.

15. A sanitary unit, preferably a sanitary unit arranged at least partially in a kitchen base unit, with a system according to claim 1.

16. A method for controlling a sanitary unit, preferably a sanitary unit arranged at least partially in a kitchen base cabinet, with a system according to claim 1, comprising the steps of:
establishing the wireless connection between the control device and the operating device(s),
determining the signal strength of the wireless connection by the control device and/or the operating device(s),
notifying the user of the sanitary unit status after the signal strength exceeds and/or falls below a predeterminable threshold, and
providing the function(s) to be controlled after a predeterminable period of time has elapsed and/or after the user confirms the status.
